(19) United States
(12) Patent Application Publication
(10) Pub. No.: US 2023/0089235 A1
(43) Pub. Date: Mar. 23, 2023

(54) TRANSACTION PROCESSING METHOD AND APPARATUS, MEDIUM, AND ELECTRONIC DEVICE

(71) Applicant: Tencent Technology (Shenzhen) Company Limited, Shenzhen (CN)

(72) Inventors: Xiaoyi ZHANG, Shenzhen (CN); Runzeng GUO, Shenzhen (CN)

(73) Assignee: Tencent Technology (Shenzhen) Company Limited, Shenzhen (CN)

(21) Appl. No.: 17/992,688

(22) Filed: Nov. 22, 2022

Related U.S. Application Data
(63) Continuation of application No. PCT/CN2022/091063, filed on May 6, 2022.

(30) Foreign Application Priority Data
Jun. 7, 2021 (CN) 202110654338.9

(51) Int. Cl. G06Q 20/40

(52) U.S. Cl. CPC G06Q 20/401; G06Q 2220/00

(57) ABSTRACT

This application relates to the field of blockchain technologies, and specifically, to a transaction processing method and apparatus, a computer-readable medium, and an electronic device. The transaction processing method includes: performing availability detection on blockchain nodes according to transaction data recorded in a blockchain network, and determining whether each of the blockchain nodes is a normal node or an abnormal node; and transmitting, when a transaction request is generated through the abnormal node, the transaction request to the normal node, and cooperatively processing the transaction request through the abnormal node and the normal node. In the embodiments of this application, the transaction service continuity and stability and reliability can be improved.

### RELATED APPLICATION

This application is a continuation of International Application No. PCT/CN2022/091063 filed May 6, 2022, which claims priority to Chinese Patent Application No. 2021106543389, entitled “TRANSACTION PROCESSING METHOD AND APPARATUS, MEDIUM, AND ELECTRONIC DEVICE” and filed with the China National Intellectual Property Administration on Jun. 7, 2021. The contents of International Application No. PCT/CN2022/091063 and Chinese Patent Application No. 2021106543389 are each incorporated herein by reference in their entirety.

### FIELD OF THE TECHNOLOGY

This application relates to the field of blockchain technologies, and in particular, to a transaction processing technology in a blockchain.

### BACKGROUND OF THE DISCLOSURE

In the massive online and offline transaction services, it is inevitable that abnormal or failed transactions occur due to device failure or other factors. How to eliminate faults quickly and accurately is the key to ensuring the service continuity and stability and reliability of transaction services.

### SUMMARY

Embodiments of this application provide a transaction processing method, a transaction processing apparatus, a computer-readable medium, and an electronic device, which can quickly and accurately eliminate faults in a transaction service system, thereby ensuring service continuity and stability and reliability of transaction services.

According to an aspect of the embodiments of this application, a transaction processing method is provided, including: performing availability detection on blockchain nodes according to transaction data recorded in a blockchain network, and determining whether each of the blockchain nodes is a normal node or an abnormal node; and transmitting, when a transaction request is generated through the abnormal node, the transaction request to the normal node, and cooperatively processing the transaction request through the abnormal node and the normal node.

According to an aspect of the embodiments of this application, a transaction processing apparatus is provided, including: a detection module, configured to perform availability detection on blockchain nodes according to transaction data recorded in a blockchain network, and determine whether each of the blockchain nodes is a normal node or an abnormal node; and a processing module, configured to transmit, when a transaction request is generated through the abnormal node, the transaction request to the normal node, and cooperatively process the transaction request through the abnormal node and the normal node.

According to an aspect of the embodiments of this application, a computer-readable medium is provided, storing a computer program, the computer program, when executed by a processor, implementing the transaction processing method in the technical solution.

According to an aspect of the embodiments of this application, an electronic device is provided, including: a processor; and a memory, configured to store executable instructions of the processor, the processor being configured to perform the transaction processing method in the technical solution by executing the executable instructions.

According to an aspect of the embodiments of this application, a computer program product or a computer program is provided, the computer program product or the computer program including computer instructions, the computer instructions being stored in a computer-readable storage medium. A processor of a computer device reads the computer instructions from the computer-readable storage medium, and executes the computer instructions, to cause the computer device to perform the transaction processing method in the technical solution.

In the technical solution provided in the embodiments of this application, a solution in which a normal node may assist an abnormal node in completing transaction processing through data transmission between the abnormal node and the normal node is used, which not only resolves a problem of an abnormal transaction or failed transaction on the abnormal node but also avoids transaction interruption, thereby improving the continuity and stability and reliability of transaction services and providing long-term autonomous disaster recovery capability for a service system.

### BRIEF DESCRIPTION OF THE DRAWINGS

FIG. 1 is a schematic composition diagram of a blockchain system.

FIG. 2 is a composition structure of a blockchain maintained in a blockchain network.

FIG. 3 is a schematic diagram of a new block generation process.

FIG. 4 a schematic flowchart of steps of a transaction processing method according to an embodiment of this application.

FIG. 5 is a service flowchart of generating transaction data according to an embodiment of this application.

FIG. 6 is a schematic service flowchart of performing fault detection according to an embodiment of this application.

FIG. 7 is a schematic service flowchart of performing fault recovery according to an embodiment of this application.

FIG. 8 is a schematic flowchart of a step of performing availability detection on a blockchain node according to an embodiment of this application.

FIG. 9 is a schematic flowchart of a step of counting a quantity of transaction failures according to an embodiment of this application.

FIG. 10 is a schematic flowchart of a step of performing transaction request transmission according to an embodiment of this application.

FIG. 11 is a schematic flowchart of a step of cooperatively processing a transaction request through an abnormal node and a normal node according to an embodiment of this application.

FIG. 12 is a schematic structural block diagram of a transaction processing apparatus according to an embodiment of this application.

FIG. 13 is a schematic structural block diagram of a computer system adapted to implement an electronic device according to an embodiment of this application.

### DETAILED DESCRIPTION

The technical solution provided in the embodiments of this application is mainly applied to transaction service scenarios such as online payment and transfer implemented based on blockchain technologies. With the help of a smart contract and block content of the blockchain technologies, a service processing state and capability of offline devices may be detected and adjusted accordingly, so as to ensure that a transaction service system has relatively strong service continuity and stability and reliability.

Blockchain is an anti-counterfeiting, anti-tampering, and traceable shared digital ledger that has a chained-block data structure and is built by using a transparent and trusted rule in a peer-to-peer network environment. The chained-block data structure is a data structure that stores transactions that occur in a period of time in blocks, and connects blocks into a chain in chronological order by using a cryptographic algorithm. The ledger is distributed to all member nodes in a blockchain network. In a block sequence chain connected through a hash password algorithm, history records of asset transactions occurring between peer-to-peer nodes in a network are permanently recorded. All confirmed and proven transactions are linked to a latest block from the beginning of the chain, so that a blockchain is obtained. The blockchain may act as a single fact source, and members in the blockchain network can view only transactions related to the members.

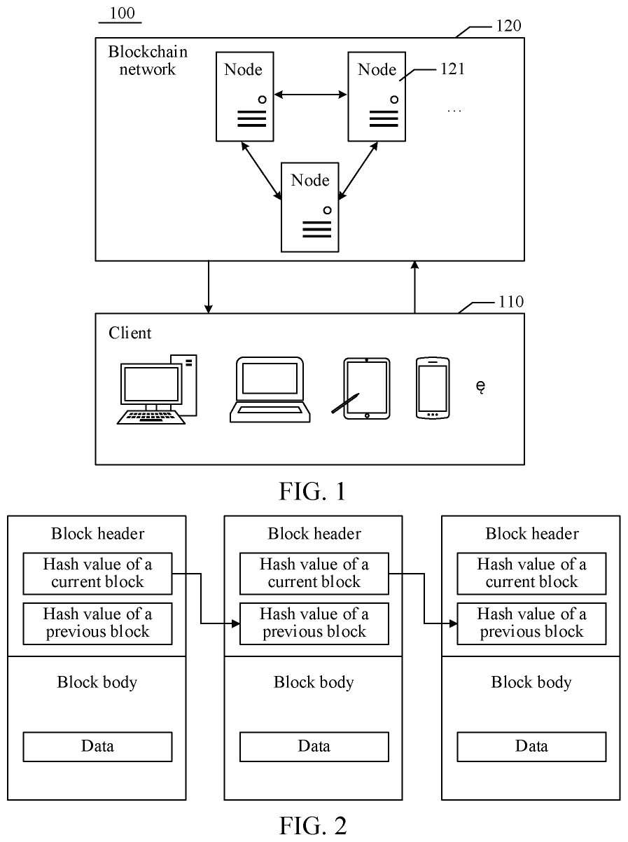

FIG. 1 is a schematic composition diagram of a blockchain system. A blockchain system 100 includes at least one client 110 and a blockchain network 120, the blockchain network 120 including at least one blockchain node 121. The client 110 may be various electronic devices such as a smartphone, a tablet computer, a notebook computer, a desktop computer, a smart wearable device, a smart in-vehicle device, a smart payment terminal, and a facial recognition terminal. The client 110 may provide a blockchain data service to a user by using a corresponding client application installed thereon. The blockchain node 121 may be a terminal device or a server, for example, the blockchain node 121 may be an independent physical service or may be a server cluster composed of a plurality of physical servers, or may be a cloud server that provides cloud computing services.

In the blockchain network 120, each blockchain node 121 may receive input information during normal operating, and maintain shared data in the blockchain network based on the received input information. To ensure the interchange of information, there may be information connections among the blockchain nodes 121, and the blockchain nodes 121 may transmit information through the information connections. For example, when any blockchain node 121 in the blockchain network 120 receives input information and broadcasts the input information in the blockchain network 120, other blockchain nodes 121 in the blockchain network 120 obtain the input information according to a consensus algorithm, and store the input information as the shared data.

The blockchain nodes 121 in the blockchain network 120 all have corresponding node identifiers, and the blockchain nodes 121 in the blockchain network 120 all may store node identifiers of other blockchain nodes in the same blockchain network, to subsequently broadcast a generated block to the other nodes in the blockchain network 120 according to the node identifiers of the other blockchain nodes. The blockchain node 121 may maintain a node identifier list shown in Table 1, and a node name and a node identifier are correspondingly stored in the node identifier list. Anode identifier may be an Internet Protocol (IP) address and any other type of information capable of identifying the node. Table 1 is a node identifier list by using the IP address as an example.

TABLE 1

| Node name | Node identifier |
|---|---|
| Node 1 | 117, 114, 151, 174 |
| Node 2 | 117, 116, 189, 145 |
| . . . | . . . |
| Node N | 119, 123, 789, 258 |

FIG. 2 is a composition structure of a blockchain maintained in a blockchain network. As shown in FIG. 2, a blockchain is formed by a plurality of sequentially connected blocks. Each time new data needs to be written into the blockchain, the data needs to be gathered to a newly generated block. The newly generated block is uploaded to a tail end of the blockchain, and it may be ensured, by using a consensus algorithm, that newly added blocks in the blockchain nodes 121 are completely the same. Data of a current block is recorded in a block body of each block, and a hash value of a previous block connected to the current block is simultaneously stored in a block header of each block. If transaction data in the previous block changes, a hash value of the current block also changes. Therefore, data uploaded to the blockchain network is difficult to be tempered, so that reliability of shared data can be improved.

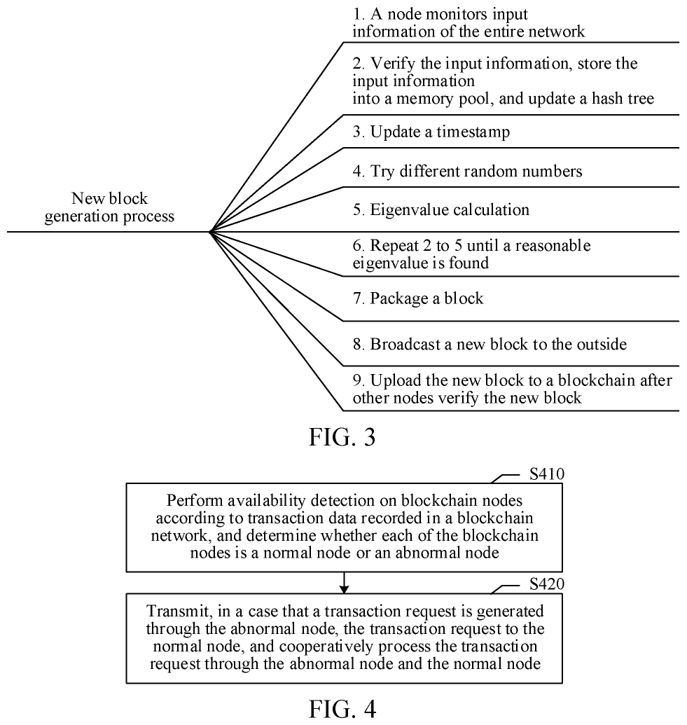

FIG. 3 is a schematic diagram of a new block generation process. As shown in FIG. 3, when blocks are generated in a blockchain, a blockchain node first verifies received input information. After the verification is completed, the input information is stored in a memory pool, and a hash tree used for recording the input information is updated. Next, a timestamp is updated to a time when the input information is received, different random numbers are tried, and eigenvalue calculation is performed for a plurality of times, so that the calculated eigenvalue may satisfy the following formula:

SHA256(SHA256(version+prev_hash+merkle_root+ntime+nbits+x))<TARGET

where SHA256 is an eigenvalue algorithm used for calculating an eigenvalue; version (a version number) is version information of a related block protocol in the blockchain; prev_hash is a block header eigenvalue of a parent block (that is, a connected previous block) of a current block; merkle_root is an eigenvalue of the input information; ntime represents the update time when the timestamp is updated; nbits represents the current difficulty, which is a fixed value within a period of time, and will be determined again after a fixed period of time has passed; x represents the random number; and TARGET represents an eigenvalue threshold, which may be determined according to nbits.

In this way, when the eigenvalue that meets the above formula is calculated, the information may be correspondingly stored to generate the block header and the block body to obtain the current block. Subsequently, the node where the blockchain is located respectively transmits, according to the node identifiers of other blockchain nodes in the blockchain network, a newly generated block to the other blockchain nodes in the blockchain network in which the blockchain node is located, and the other blockchain nodes verify the newly generated block and add the newly generated block after the verification to the blockchain stored in other blockchain nodes.

The technical solutions of the transaction processing method, the transaction processing apparatus, the computer readable medium, and the electronic device provided in this application are described in detail below with reference to specific implementations.

FIG. 4 a schematic flowchart of steps of a transaction processing method according to an embodiment of this application. The transaction processing method may be performed by an electronic device, or may be performed by a terminal device as the client shown in FIG. 1, or may be performed by a blockchain node in the blockchain network. In this embodiment of this application, a description is made by using an example in which the blockchain node performs the transaction processing method. As shown in FIG. 4, the transaction processing method may include the following step S410 and step S420.

Step S410. Perform availability detection on blockchain nodes according to transaction data recorded in a blockchain network, and determine whether each of the blockchain nodes is a normal node or an abnormal node.

In an embodiment of this application, a blockchain network may be established based on an offline Internet of things (IOT), and each block may be considered as an encrypted file including a device transaction detail, a timestamp, and a block hash. In this embodiment of this application, a size of a block is specified as 20 M, and a complete record of a single transaction is about 1 k.

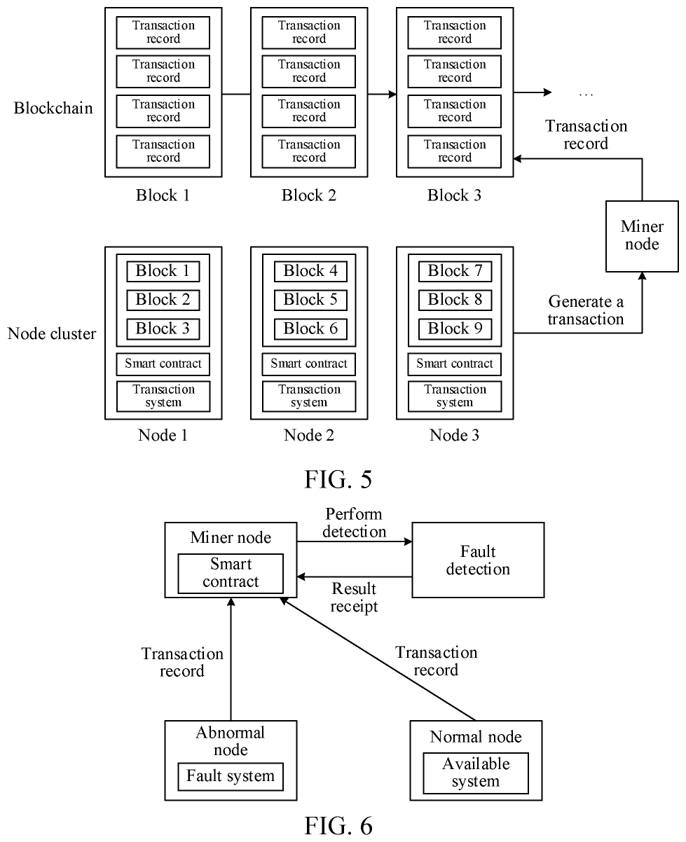

FIG. 5 is a service flowchart of generating transaction data according to an embodiment of this application. As shown in FIG. 5, a blockchain is maintained on a blockchain network formed by a node cluster, and each node stores a transaction system and a smart contract of the blockchain network, as well as a plurality of blocks generated locally on the blockchain node. For example, a node 1 stores a block 1 to a block 3, a node 2 stores a block 4 to a block 6, and a node 3 stores a block 7 to a block 9. Each block may be considered as an encrypted file including a plurality of transaction records. For example, the encrypted file may be encrypted and decrypted by using a symmetric key. Each IOT device has a unique decryption key. The decryption key is burned in a device system layer Rom and cannot be forcibly obtained by technical means. Through a private key, each IOT device may obtain data information in an encrypted block. When a transaction is generated on a blockchain node, a miner node may be selected to write a transaction record to a block, and then upload the block to a blockchain through an uploading operation.

FIG. 6 is a schematic service flowchart of performing fault detection (that is, availability detection) according to an embodiment of this application. As shown in FIG. 6, a miner node may obtain a transaction record broadcasted by a blockchain node in a blockchain network, perform, by using a smart contract configured on the miner node, availability detection on each blockchain node that generates the transaction record, and may obtain a result receipt representing a node type based on a detection result, for example, may determine which blockchain nodes are abnormal nodes and which blockchain nodes are normal nodes. A transaction system carried on the abnormal node is marked as a failed system, and a transaction system carried on the normal node is marked as an available system.

Step S420. Transmit, when a transaction request is generated through the abnormal node, the transaction request to the normal node, and cooperatively process the transaction request through the abnormal node and the normal node.

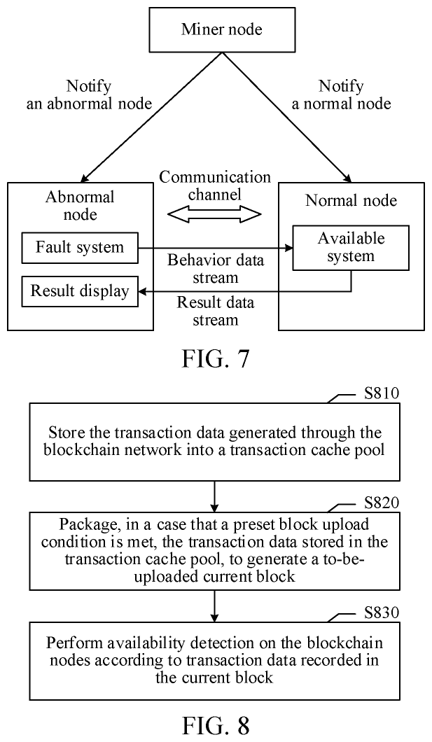

FIG. 7 is a schematic service flowchart of performing fault recovery according to an embodiment of this application. As shown in FIG. 7, when determining that abnormality occurs in a blockchain node, a miner node selects an idle blockchain node with a normal transaction from a transaction ledger as a normal node to assist the abnormal node in processing a transaction request, and notifies in the network that a data communication channel (long connection) is established between the abnormal node and the normal node.

The abnormal node receives data information from the miner node, the data information being attached with a unique identifier and IP information of the normal node. Further, the abnormal node may establish a connection to the normal node based on this information. When a transaction request is generated through the abnormal node, an event (for example, a click event or a face swiping event) that the abnormal node interacts with the outside world may be converted into a behavior data stream, and the behavior data stream is transmitted to the normal node through the established connection.

After receiving the behavior data stream from the abnormal node, the normal node helps the abnormal node by using a system availability of the normal node to process the behavior data stream and feeds back a processing result of the behavior data stream (that is, a result data stream) to the abnormal node. For this process, the normal node displays nothing in an interface. If in this process, the normal node also needs to process a transaction request generated through the normal node (currently processing the transaction of the abnormal node), then a new thread is started to process the transaction request in parallel, but the execution process of the transaction request is fed back to the interface for interaction display.

After processing the transaction request of the abnormal node, the normal node feeds back a transaction processing result to the abnormal node, and the abnormal node displays the transaction processing result (whether the payment is successful, how much the user has been deducted, how much the user has been exempted, or the like).

So far, the abnormal node has completed disaster recovery through forwarding of the data stream with the help of the system of the normal node.

In the transaction processing method provided in this embodiment of this application, a solution in which a normal node may assist an abnormal node in completing transaction processing through data transmission between the abnormal node and the normal node is used, which not only resolves a problem of an abnormal transaction or failed transaction on the abnormal node but also avoids a problem of transaction interruption, thereby improving the continuity and stability of the transaction services and providing long-term autonomous disaster recovery capability for the service system.

FIG. 8 is a schematic flowchart of a step of performing availability detection on a blockchain node according to an embodiment of this application. As shown in FIG. 8, based on the foregoing embodiments, step S410 of performing availability detection on blockchain nodes according to transaction data recorded in a blockchain network may include the following step S810 to step S830.

Step S810. Store the transaction data generated through the blockchain network into a transaction cache pool.

Each blockchain node may maintain a transaction cache pool. After any blockchain node in a blockchain network generates transaction data, the blockchain node may broadcast the generated transaction data to other blockchain nodes in the blockchain network. Correspondingly. The other blockchain nodes that receive the transaction data may temporarily store the transaction data in transaction cache pools for upload processing.

Step S820. Package, when a preset block upload condition is met, the transaction data stored in the transaction cache pool, to generate a to-be-uploaded current block.

The block upload condition may include, for example, a time condition or a capacity condition. The time condition may be that a length of time from an uploading time of a previous block to an uploading time of a current block in the blockchain network has reached a specific time threshold, and the capacity condition may be specifically that a quantity of pieces of transaction data in the transaction cache pool reaches a specific quantity threshold or a storage capacity threshold.

Packaging and uploading operations may be generally performed by a miner node. After generating a to-be-uploaded current block, the miner node may broadcast the current block to the blockchain network, and a consensus node in the blockchain network performs consensus certification on the current block, and uploads the current block to the blockchain after the certification. Subsequently, the transaction cache pool may be cleared, and new transaction data is continuously accumulated in the cleared transaction cache pool.

Step S830. Perform availability detection on the blockchain nodes according to transaction data recorded in the current block.

In an embodiment of this application, the method of performing availability detection on the blockchain nodes according to transaction data recorded in the current block includes: counting a quantity of transaction failures and a transaction failure rate of each of the blockchain nodes according to the transaction data recorded in the current block; determining, when the quantity of transaction failures and the transaction failure rate of a blockchain node each reach a corresponding parameter threshold, that the blockchain node is an abnormal node with availability failure; and determining, when at least one of the quantity of transaction failures or the transaction failure rate of a blockchain node does not reach the corresponding parameter threshold, that the blockchain node is an available normal node.

In this embodiment of this application, a quantity of transaction failures and a transaction failure rate of each blockchain node may be counted simultaneously. If both a quantity of transaction failures and a transaction failure rate of a blockchain node are relatively large, it indicates that the blockchain node is most likely an abnormal node.

In an embodiment of this application, the method of counting a quantity of transaction failures and a transaction failure rate of each of the blockchain nodes according to the transaction data recorded in the current block may include: counting the quantity of transaction failures of each of the blockchain nodes according to the transaction data recorded in the current block; and counting the transaction failure rate of the blockchain node when the quantity of transaction failures reaches a preset quantity-of-times threshold.

In this embodiment of this application, a quantity of transaction failures of each blockchain node is first counted, and for a blockchain node whose quantity of transaction failures reaches a preset quantity-of-times threshold, a transaction failure rate of the blockchain node is further counted. For a blockchain node whose quantity of transaction failures is lower than the quantity-of-times threshold, the blockchain node may be directly determined as a normal node without counting a transaction failure rate of the blockchain node. In this way, computing resources required for performing availability detection on the blockchain nodes may be reduced to a certain extent.

For example, if it is determined, based on the transaction data recorded in the current block, that a quantity of transaction failures of a blockchain node reaches five times or more, counting of a transaction failure rate of the blockchain node is started for fault determining. If the transaction failure rate of the blockchain node is greater than 80%, it may be determined that the blockchain node has availability failure and is an abnormal node. Disaster recovery is required for the abnormal node to prevent transaction abnormality or transaction failure from continuously occurring on the abnormal node.

FIG. 9 is a schematic flowchart of a step of counting a quantity of transaction failures according to an embodiment of this application. As shown in FIG. 9, based on the foregoing embodiments, the method of counting a quantity of transaction failures of each of the blockchain nodes according to the transaction data recorded in the current block may include the following step S910 to step S940.

Step S910. Perform completeness check on the transaction data recorded in the current block, and determine whether a transaction process of the transaction data is complete.

Step S920. Determine that the transaction data is transaction failure data when the transaction process of the transaction data is incomplete.

Step S930. Obtain a node identifier of a blockchain node for processing the transaction data.

Step S940. Count the transaction failure data according to the node identifier, to obtain the quantity of transaction failures of each of the blockchain nodes.

Block content mainly includes transaction data, and the transaction data is divided into two parts: a transaction starting point (that is, transaction starting data) and a transaction end point (that is, transaction end data). The data of two types may be associated by using a single process identifier (the process identifier is a process identifier of a transaction process to which the transaction starting data and the transaction end data belong) or may be associated by using a specific relationship, so that unique transaction end data corresponding to the transaction starting data may be found through the transaction starting data. In addition, a transaction status of each block is adjusted based on a smart contract. Because when performing a transaction, each blockchain node (for example, a face swiping IOT device) writes transaction information (a starting point and an end point) of a single process into a specific block, for the smart contract, a transaction status of any block may be learned, to determine availability of the blockchain node.

In this embodiment of this application, start end matching may be performed on all transaction processes recorded in a block, a transaction process with only head but not tail (that is, a transaction process that has only transaction starting data but no transaction end data) is considered as a failed transaction process, that is, considered as an incomplete transaction process of the transaction data. When the entire block completes recording, a total quantity of failed transaction processes in the corresponding block is counted by using a smart contract, and grouping counting is performed according to a node identifier, to determine a quantity of transaction failures of each blockchain node.

Based on the manner of recording the transaction process, in an embodiment of this application, the method of performing completeness check on the transaction data recorded in the current block may include: performing data screening on the transaction data recorded in the current block according to the transaction process, to obtain transaction starting data generated when a transaction is initiated; obtaining a process identifier used for representing a transaction process to which the transaction starting data belongs; performing, according to the process identifier, matching detection on the transaction starting data and another transaction data recorded in the current block, to determine whether transaction end data belonging to the same transaction process as the transaction starting data exists in the current block, the transaction end data being data generated when the transaction is ended; determining that the transaction process of the transaction data is complete when it is determined that the transaction end data belonging to the same transaction process as the transaction starting data exists in the current block; and determining that the transaction process of the transaction data is incomplete when the transaction end data belonging to the same transaction process as the transaction starting data does not exist in the current block.

In an embodiment of this application, in addition to performing availability detection according to the to-be-uploaded current block, one or more historical blocks that are recently uploaded to a blockchain may further be obtained, and availability detection is performed on the blockchain nodes according to transaction data recorded in the historical blocks.

In an embodiment of this application, transaction data of one or more historical blocks and transaction data of the to-be-uploaded current block may further be combined, and availability detection is performed on the blockchain nodes based on the combined transaction data.

Specifically, when availability detection is performed on the blockchain nodes according to the transaction data recorded in the historical blocks or the combined transaction data, the manner of performing availability detection on the blockchain nodes based on the transaction data recorded in the current block described above may be used, that is, the quantity of transaction failures and the transaction failure rate of each of the blockchain nodes may be determined based on the transaction data recorded in the historical blocks or the combined transaction data, and it is determined whether each blockchain node is a normal node or an abnormal node according to a relationship between a corresponding parameter threshold and each of the quantity of transaction failures and the transaction failure rate of each of the blockchain nodes.

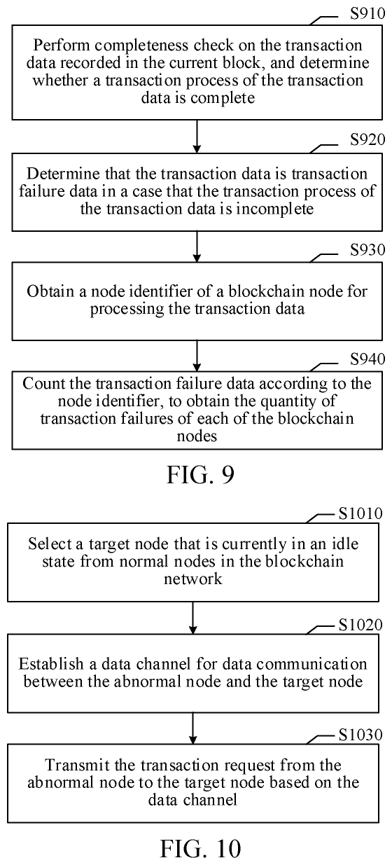

FIG. 10 is a schematic flowchart of a step of performing transaction request transmission according to an embodiment of this application. As shown in FIG. 10, based on the foregoing embodiments, step S420 of transmitting the transaction request to the normal node may include the following step S1010 to step S1030.

Step S1010. Select a target node that is currently in an idle state from normal nodes in the blockchain network.

By monitoring a working status of each normal node, it may be determined whether each normal node is currently processing a transaction service. If a normal node currently does not process a transaction service, it may be determined that the normal node is in an idle state, and the normal node may be used as a candidate node. When there are a plurality of candidate nodes in the idle state, in this embodiment of this application, one node may be randomly selected as a target node.

In an embodiment of this application, in this step, a plurality of target nodes may be simultaneously selected, so that a relationship between a main node and a standby node is formed among the plurality of target nodes, thereby improving transaction service processing reliability and processing efficiency.

Step S1020. Establish a data channel for data communication between the abnormal node and the target node.

In this embodiment of this application, a network access address of the target node may be sent to the abnormal node, so that the abnormal node may establish a data channel with the target node. The network access address may include an Internet Protocol (IP) address and a port number. The data channel established between the abnormal node and the target node may be, for example, a long connection channel based on a transmission control protocol (TCP) communication protocol.

Step S1030. Transmit the transaction request from the abnormal node to the target node based on the data channel.

After the data channel is established, point to point data transmission may be performed between the abnormal node and the target node, to implement a solution of cooperatively performing transaction processing by using the abnormal node and the normal node.

In an embodiment of this application, step S1010 of selecting a target node that is currently in an idle state from normal nodes in the blockchain network may include: selecting a blockchain node whose leisure degree is highest from the blockchain network as a miner node for packaging the current block; and selecting the target node that is currently in the idle state from the normal nodes in the blockchain network through the miner node.

In an embodiment of this application, the method of selecting a blockchain node whose leisure degree is highest from the blockchain network may include: counting a quantity of transactions of each of the blockchain nodes in the blockchain network according to a preset time period; screening the quantity of transactions of each of the blockchain nodes according to transaction data recorded in a preset quantity of blocks that are recently uploaded, to obtain a quantity of recent transactions of each of the blockchain nodes; and selecting a blockchain node with a smallest quantity of recent transactions as the blockchain node whose leisure degree is highest.

For example, in this embodiment of this application, it may be specified that each blockchain node reports a transaction processed by the blockchain node every 12 hours, each time one transaction is generated, a quantity of transactions is increased by 1, and when no transaction is generated, the quantity of transactions is 0. In this embodiment of this application, transaction data recorded in three continuous blocks may be obtained, quantities of transactions counted by blockchain nodes are screened to obtain quantities of recent transactions, then the quantities of recent transactions are arranged in ascending order, to obtain a node list, a top-ranked node in the node list is selected as a blockchain node whose leisure degree is highest, further the node is used as a miner node for block packaging and uploading, and a target node that establishes a data channel with the abnormal node is selected from the normal nodes in the blockchain network by using the miner node.

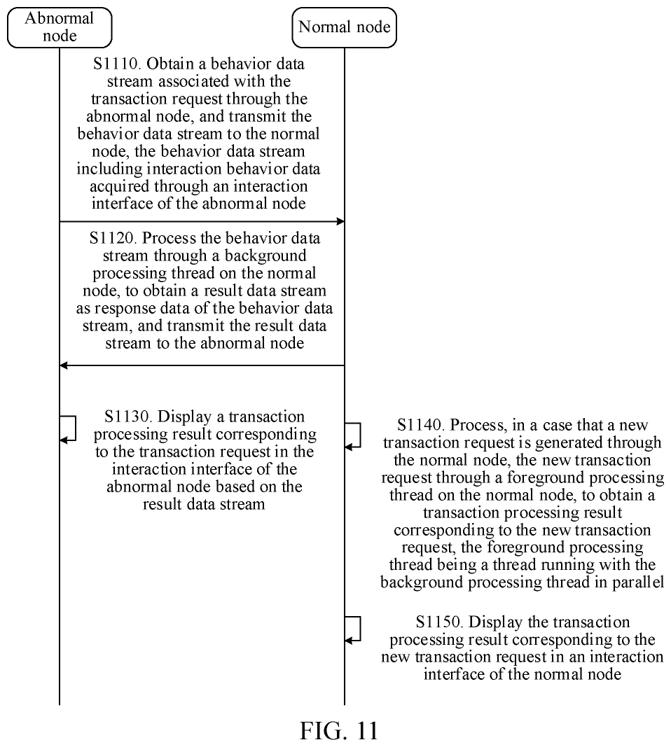

FIG. 11 is a schematic flowchart of a step of cooperatively processing a transaction request through an abnormal node and a normal node according to an embodiment of this application. As shown in FIG. 11, based on the foregoing embodiments, step S420 of cooperatively processing the transaction request by using the abnormal node and the normal node may include the following step S1110 to step S1150.

Step S1110. Obtain a behavior data stream associated with the transaction request through the abnormal node, and transmit the behavior data stream to the normal node, the behavior data stream including interaction behavior data acquired through an interaction interface of the abnormal node.

Step S1120. Process the behavior data stream through a background processing thread on the normal node, to obtain a result data stream as response data of the behavior data stream, and transmit the result data stream to the abnormal node.

Step S1130. Display a transaction processing result corresponding to the transaction request in the interaction interface of the abnormal node based on the result data stream.

Step S1140. Process, when a new transaction request is generated through the normal node, the new transaction request through a foreground processing thread on the normal node, to obtain a transaction processing result corresponding to the new transaction request, the foreground processing thread being a thread running with the background processing thread in parallel.

Step S1150. Display the transaction processing result corresponding to the new transaction request in an interaction interface of the normal node.

In this embodiment of this application, the normal node may process, through a background processing thread, the transaction request generated on the abnormal node and visually displays a processing result on the abnormal node, so that the user has no awareness of node fault detection and fault repair. In addition, when a new transaction request is generated on the normal node, the normal node may process the new transaction request by using a foreground processing thread that is run in parallel, and the processing process does not have any impact on the processing process of the transaction request of the abnormal node running in the background.

Although the steps of the method in this application are described in a specific order in the accompanying drawings, this does not require or imply that the steps have to be performed in the specific order, or all the steps shown have to be performed to achieve an expected result. Additionally or alternatively, some steps may be omitted, a plurality of steps may be combined into one step for execution, and/or one step may be decomposed into a plurality of steps for execution, and the like.

The following describes apparatus embodiments of this application, and the apparatus embodiments can be used for performing the transaction processing method in the foregoing embodiments of this application.

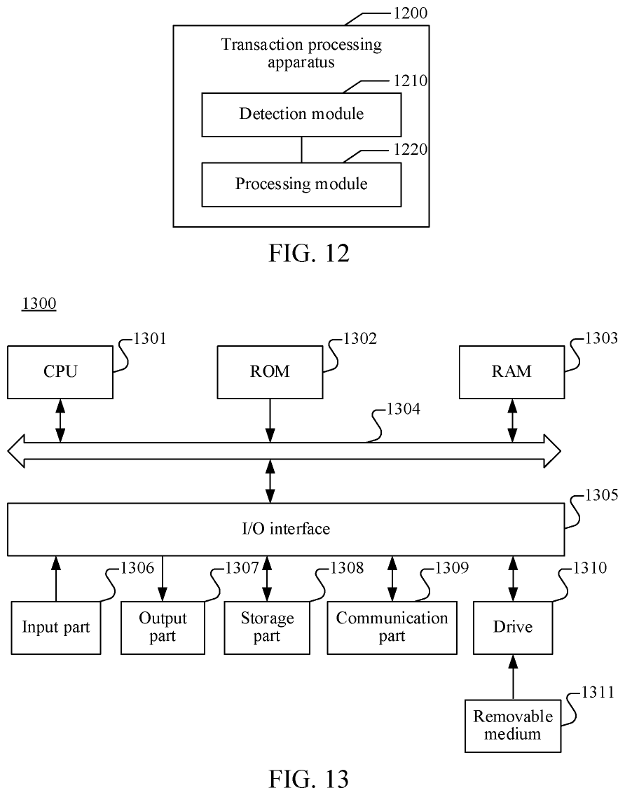

FIG. 12 is a schematic structural block diagram of a transaction processing apparatus 1200 according to an embodiment of this application. As shown in FIG. 12, the transaction processing apparatus 1210 may mainly include: a detection module 1210, configured to perform availability detection on blockchain nodes according to transaction data recorded in a blockchain network, and determine whether each of the blockchain nodes is a normal node or an abnormal node; and a processing module 1220, configured to transmit, when a transaction request is generated through the abnormal node, the transaction request to the normal node, and cooperatively process the transaction request through the abnormal node and the normal node.

In some embodiments of this application, based on the foregoing embodiments, the detection module 1210 includes: a cache module, configured to store the transaction data generated through the blockchain network into a transaction cache pool, a packaging module, configured to package, when a preset block upload condition is met, the transaction data stored in the transaction cache pool, to generate a to-be-uploaded current block; and a current block detection module, configured to perform availability detection on the blockchain nodes according to transaction data recorded in the current block.

In some embodiments of this application, based on the foregoing embodiments, the current block detection module includes: a counting module, configured to count a quantity of transaction failures and a transaction failure rate of each of the blockchain nodes according to the transaction data recorded in the current block; an abnormality determining module, configured to determine, when the quantity of transaction failures and the transaction failure rate of the blockchain node each reach a corresponding parameter threshold, that the blockchain node is an abnormal node with availability failure; and a normality determining module, configured to determine, when at least one of the quantity of transaction failures or the transaction failure rate of the blockchain node does not reach the corresponding parameter threshold, that the blockchain node is an available normal node.

In some embodiments of this application, based on the foregoing embodiments, the counting module includes: a quantity of transaction failures counting module, configured to count the quantity of transaction failures of each of the blockchain nodes according to the transaction data recorded in the current block; and a failure rate counting module, configured to count the transaction failure rate of the blockchain node when the quantity of transaction failures reaches a preset quantity-of-times threshold.

In some embodiments of this application, based on the foregoing embodiments, the counting module is further configured to: perform completeness check on the transaction data recorded in the current block, and determine whether a transaction process of the transaction data is complete; determine that the transaction data is transaction failure data when the transaction process of the transaction data is incomplete; obtain a node identifier of a blockchain node for processing the transaction data; and count the transaction failure data according to the node identifier, to obtain the quantity of transaction failures of each of the blockchain nodes.

In some embodiments of this application, based on the foregoing embodiments, the counting module is further configured to: perform data screening on the transaction data recorded in the current block according to the transaction process, to obtain transaction starting data generated when a transaction is initiated; obtain a process identifier used for representing a transaction process to which the transaction starting data belongs; perform, according to the process identifier, matching detection on the transaction starting data and another transaction data recorded in the current block, to determine whether transaction end data belonging to the same transaction process as the transaction starting data exists in the current block, the transaction end data being data generated when the transaction is ended; determine that the transaction process of the transaction data is complete when it is determined that the transaction end data belonging to the same transaction process as the transaction starting data exists in the current block; and determine that the transaction process of the transaction data is incomplete when the transaction end data belonging to the same transaction process as the transaction starting data does not exist in the current block.

In some embodiments of this application, based on the foregoing embodiments, the detection module 1210 further includes: a historical block obtaining module, configured to obtain one or more historical blocks that are recently uploaded to a blockchain; and a historical block detection module, configured to perform availability detection on the blockchain node according to transaction data recorded in the historical blocks.

In some embodiments of this application, based on the foregoing embodiments, the processing module 1220 includes: a target selection module, configured to select a target node that is currently in an idle state from normal nodes in the blockchain network; a channel establishment module, configured to establish a data channel for data communication between the abnormal node and the target node; and a request transmission module, configured to transmit the transaction request from the abnormal node to the target node based on the data channel.

In some embodiments of this application, based on the foregoing embodiments, the target selection module includes: a miner node selection module, configured to select a blockchain node whose leisure degree is highest from the blockchain network as a miner node for packaging the current block; and a target node selection module, configured to select the target node that is currently in the idle state from the normal nodes in the blockchain network through the miner node.

In some embodiments of this application, based on the foregoing embodiments, the miner node selection module is configured to count a quantity of transactions of each of the blockchain nodes in the blockchain network according to a preset time period; screen the quantity of transactions of each of the blockchain nodes according to transaction data recorded in a preset quantity of blocks that are recently uploaded, to obtain a quantity of recent transactions of each of the blockchain nodes; and select a blockchain node with a smallest quantity of recent transactions as the blockchain node whose leisure degree is highest.

In some embodiments of this application, based on the foregoing embodiments, the processing module 1220 further includes: a behavior data stream transmission module, configured to obtain a behavior data stream associated with the transaction request through the abnormal node, and transmit the behavior data stream to the normal node, the behavior data stream including interaction behavior data acquired through an interaction interface of the abnormal node; a result data stream transmission module, configured to process the behavior data stream through a background processing thread on the normal node, to obtain a result data stream as response data of the behavior data stream, and transmit the result data stream to the abnormal node; and a result data stream display module, configured to display a transaction processing result corresponding to the transaction request in the interaction interface of the abnormal node based on the result data stream.

In some embodiments of this application, based on the foregoing embodiments, the transaction processing apparatus 1200 further includes: a foreground processing module, configured to process, when a new transaction request is generated through the normal node, the new transaction request through a foreground processing thread on the normal node, to obtain a transaction processing result corresponding to the new transaction request, the foreground processing thread being a thread running with the background processing thread in parallel; and a foreground display module, configured to display the transaction processing result corresponding to the new transaction request in an interaction interface of the normal node.

Details of the transaction processing apparatus in various embodiments of this application have been specifically described in the corresponding method embodiments. Therefore, details are not described herein again.

FIG. 13 is a schematic structural block diagram of a computer system adapted to implement an electronic device according to an embodiment of this application.

The computer system 1300 of the electronic device shown in FIG. 13 is merely an example, and does not constitute any limitation on functions and use ranges of the embodiments of this application.

As shown in FIG. 13, the computer system 1300 includes a central processing unit (CPU) 1301. The CPU may perform various appropriate actions and processing according to a program stored in a read-only memory (ROM) 1302 or a program loaded from a storage portion 1308 into a random access memory (RAM) 1303. The RAM 1303 further stores various programs and data required for system operations. The processor 1301, the ROM 1302, and the RAM 1303 are connected to each other through a bus 1304. An input/output (V/O) interface 1305 is also connected to the bus 1304.

The following components are connected to the I/O interface 1305: an input part 1306 including a keyboard, a mouse, or the like; an output part 1307 including a cathode ray tube (CRT), a liquid crystal display (LCD), a speaker, or the like; a storage part 1308 including hard disk, etc.; and a communication part 1309 including a network interface card such as a local area network card or a modem, etc. The communication part 1309 performs communication processing by using a network such as the Internet. A drive 1310 is also connected to the I/O interface 1305 as required. A removable medium 1311, such as a disk, an optical disc, a magneto-optical disc, or a semiconductor memory, is installed on the drive 1310 as required, so that a computer program read from the removable medium is installed in the storage part 1308 as required.

Particularly, according to an embodiment of this application, the processes described in the method flowcharts may be implemented as computer software programs. For example, this embodiment of this application includes a computer program product, the computer program product includes a computer program carried on a computer-readable medium, and the computer program includes program code used for performing the methods shown in the flowcharts. In such an embodiment, by using the communication part 1309, the computer program may be downloaded and installed from a network, and/or installed from the removable medium 1311. When the computer program is executed by the CPU 1301, the various functions defined in the system of this application are executed.

The computer-readable medium shown in the embodiments of this application may be a computer-readable signal medium or a computer-readable storage medium or any combination of two. The computer-readable storage medium may be, for example, but is not limited to, an electrical, magnetic, optical, electromagnetic, infrared, or semiconductor system, apparatus, or device, or any combination thereof. A more specific example of the computer-readable storage medium may include but is not limited to, an electrical connection having one or more wires, a portable computer magnetic disk, a hard disk, a RAM, a ROM, an erasable programmable read-only memory (EPROM), a flash memory, an optical fiber, a compact disc read-only memory (CD-ROM), an optical storage device, a magnetic storage device, or any appropriate combination thereof. In this application, the computer-readable storage medium may be any tangible medium containing or storing a program, and the program may be used by or used in combination with an instruction execution system, apparatus, or device. In this application, a computer-readable signal medium may include a data signal being in a baseband or propagated as a part of a carrier wave, the data signal carrying computer-readable program code. The data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in combination with an instruction execution system, apparatus, or device. The program code comprised in the computer-readable medium may be transmitted by using any suitable medium, comprising but not limited to: a wireless medium, a wired medium, or the like, or any suitable combination thereof.

The flowcharts and block diagrams in the accompanying drawings illustrate possible system architectures, functions, and operations that may be implemented by a system, a method, and a computer program product according to various embodiments of this application. In this regard, each box in a flowchart or a block diagram may represent a module, a program segment, or a part of code. The module, the program segment, or the part of code includes one or more executable instructions used for implementing designated logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram or a flowchart and a combination of boxes in the block diagram or the flowchart may be implemented by using a dedicated hardware-based system configured to perform a designated function or operation, or may be implemented by using a combination of dedicated hardware and a computer instruction.

Although a plurality of modules or units of a device configured to perform actions are discussed in the foregoing detailed description, such division is not mandatory. Actually, according to the implementations of this application, the features and functions of two or more modules or units described above may be specified in one module or unit. Conversely, features and functions of one module or unit described above may be further divided into a plurality of modules or units to be specified.

Through the descriptions of the foregoing implementations, a person skilled in the art easily understands that the exemplary implementations described herein may be implemented through software, or may be implemented through software located in combination with necessary hardware. Therefore, the technical solutions of the embodiments of this application may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a touch terminal, a network device, or the like) to perform the methods according to the embodiments of this application.

After considering the specification and practicing the present disclosure, a person skilled in the art may easily conceive of other implementations of this application. This application is intended to cover any variations, uses, or adaptive changes of this application. These variations, uses, or adaptive changes follow the general principles of this application and include common general knowledge or common technical means in the art, which are not disclosed in this application.

It is to be understood that this application is not limited to the precise structures described above and shown in the accompanying drawings, and various modifications and changes can be made without departing from the scope of this application. The scope of this application is subject only to the appended claims.

What is claimed is:

1. A transaction processing method, performed by an electronic device, the method comprising:
performing availability detection on blockchain nodes according to transaction data recorded in a blockchain network, and determining whether each of the blockchain nodes is a normal node or an abnormal node; and
transmitting, when a transaction request is generated through the abnormal node, the transaction request to the normal node, and cooperatively processing the transaction request through the abnormal node and the normal node.

2. The transaction processing method according to claim 1, wherein the performing availability detection comprises:
storing the transaction data generated through the blockchain network into a transaction cache pool;
packaging, when a preset block upload condition is met, the transaction data stored in the transaction cache pool, to generate a to-be-uploaded current block; and
performing availability detection on each of the blockchain nodes according to transaction data recorded in the current block.

3. The transaction processing method according to claim 2, wherein the performing availability detection on each of the blockchain nodes comprises:
counting a quantity of transaction failures and a transaction failure rate of each of the blockchain nodes according to the transaction data recorded in the current block;
determining, when the quantity of transaction failures and the transaction failure rate of the blockchain node each reach a corresponding parameter threshold, that the blockchain node is an abnormal node with availability failure; and
determining, when at least one of the quantity of transaction failures or the transaction failure rate of the blockchain node does not reach the corresponding parameter threshold, that the blockchain node is an available normal node.

4. The transaction processing method according to claim 3, wherein the counting a quantity of transaction failures and a transaction failure rate of each of the blockchain nodes comprises:
counting the quantity of transaction failures of each of the blockchain nodes according to the transaction data recorded in the current block; and
counting the transaction failure rate of the blockchain node when the quantity of transaction failures reaches a preset quantity-of-times threshold.

5. The transaction processing method according to claim 3, wherein the counting a quantity of transaction failures of each of the blockchain nodes comprises:
performing a completeness check on the transaction data recorded in the current block, and determining whether a transaction process of the transaction data is complete;
determining that the transaction data is transaction failure data when the transaction process of the transaction data is incomplete;
obtaining a node identifier of a blockchain node for processing the transaction data; and
counting the transaction failure data according to the node identifier, to obtain the quantity of transaction failures of each of the blockchain nodes.

6. The transaction processing method according to claim 5, wherein the performing a completeness check on the transaction data recorded in the current block comprises:
performing, according to the transaction process, data screening on the transaction data recorded in the current block to obtain transaction starting data generated when a transaction is initiated;
obtaining a process identifier used for representing a transaction process to which the transaction starting data belongs;
performing, according to the process identifier, matching detection on the transaction starting data and another transaction data recorded in the current block to determine whether transaction end data belonging to the same transaction process as the transaction starting data exists in the current block, the transaction end data being data generated when the transaction is ended;
determining that the transaction process of the transaction data is complete when it is determined that the transaction end data belonging to the same transaction process as the transaction starting data exists in the current block; and
determining that the transaction process of the transaction data is incomplete when the transaction end data belonging to the same transaction process as the transaction starting data does not exist in the current block.

7. The transaction processing method according to claim 2, wherein the performing availability detection on blockchain nodes according to transaction data recorded in a blockchain network further comprises:
obtaining one or more historical blocks that are recently uploaded to a blockchain; and
performing availability detection on the blockchain nodes according to transaction data recorded in the historical blocks.

8. The transaction processing method according to claim 1, wherein the transmitting the transaction request to the normal node comprises:
selecting a target node that is currently in an idle state from normal nodes in the blockchain network;
establishing a data channel for data communication between the abnormal node and the target node; and
transmitting the transaction request from the abnormal node to the target node based on the data channel.

9. The transaction processing method according to claim 8, wherein the selecting a target node comprises:
selecting a blockchain node whose leisure degree is highest from the blockchain network as a miner node for packaging the current block; and
selecting the target node that is currently in the idle state from the normal nodes in the blockchain network through the miner node.

10. The transaction processing method according to claim 9, wherein the selecting a blockchain node whose leisure degree is highest from the blockchain network comprises:
counting a quantity of transactions of each of the blockchain nodes in the blockchain network according to a preset time period;
screening the quantity of transactions of each of the blockchain nodes according to transaction data recorded in a preset quantity of blocks that are recently uploaded, to obtain a quantity of recent transactions of each of the blockchain nodes; and
selecting a blockchain node with a smallest quantity of recent transactions as the blockchain node whose leisure degree is highest.

11. The transaction processing method according to claim 1, wherein the cooperatively processing the transaction request through the abnormal node and the normal node comprises:
obtaining a behavior data stream associated with the transaction request through the abnormal node, and transmitting the behavior data stream to the normal node, the behavior data stream comprising interaction behavior data acquired through an interaction interface of the abnormal node;
processing the behavior data stream through a background processing thread on the normal node, to obtain a result data stream as response data of the behavior data stream, and transmitting the result data stream to the abnormal node; and
displaying a transaction processing result corresponding to the transaction request in the interaction interface of the abnormal node based on the result data stream.

12. The transaction processing method according to claim 11, wherein when the behavior data stream is processed through the background processing thread on the normal node, the method further comprises:
processing, when a new transaction request is generated through the normal node, the new transaction request through a foreground processing thread on the normal node, to obtain a transaction processing result corresponding to the new transaction request, the foreground processing thread being a thread running with the background processing thread in parallel; and
displaying the transaction processing result corresponding to the new transaction request in an interaction interface of the normal node.

13. A transaction processing apparatus, comprising:
a memory storing a plurality of instructions; and
a processor configured to execute the plurality of instructions, and upon execution of the plurality of instructions, is configured to:
perform availability detection on blockchain nodes according to transaction data recorded in a blockchain network, and determine whether each of the blockchain nodes is a normal node or an abnormal node; and
transmit, when a transaction request is generated through the abnormal node, the transaction request to the normal node, and cooperatively process the transaction request through the abnormal node and the normal node.

14. The transaction processing apparatus according to claim 13, wherein the processor, upon execution of the plurality of instructions, is further configured to:
store the transaction data generated through the blockchain network into a transaction cache pool;
package, when a preset block upload condition is met, the transaction data stored in the transaction cache pool, to generate a to-be-uploaded current block; and
perform availability detection on each of the blockchain nodes according to transaction data recorded in the current block.

15. The transaction processing apparatus according to claim 14, wherein the processor, upon execution of the plurality of instructions, is further configured to:
count a quantity of transaction failures and a transaction failure rate of each of the blockchain nodes according to the transaction data recorded in the current block;
determine, when the quantity of transaction failures and the transaction failure rate of the blockchain node each reach a corresponding parameter threshold, that the blockchain node is an abnormal node with availability failure; and
determine, when at least one of the quantity of transaction failures or the transaction failure rate of the blockchain node does not reach the corresponding parameter threshold, that the blockchain node is an available normal node.

16. The transaction processing apparatus according to claim 15, wherein the processor, upon execution of the plurality of instructions, is further configured to:
count the quantity of transaction failures of each of the blockchain nodes according to the transaction data recorded in the current block; and
count the transaction failure rate of the blockchain node when the quantity of transaction failures reaches a preset quantity-of-times threshold.

17. The transaction processing apparatus according to claim 16, wherein the processor, upon execution of the plurality of instructions, is further configured to:
perform a completeness check on the transaction data recorded in the current block, and determine whether a transaction process of the transaction data is complete;
determine that the transaction data is transaction failure data when the transaction process of the transaction data is incomplete;
obtain a node identifier of a blockchain node for processing the transaction data; and
count the transaction failure data according to the node identifier, to obtain the quantity of transaction failures of each of the blockchain nodes.

18. A non-transitory computer-readable storage medium storing a plurality of instructions that, when executed by a processor, is configured to cause the processor to:
perform availability detection on blockchain nodes according to transaction data recorded in a blockchain network, and determine whether each of the blockchain nodes is a normal node or an abnormal node; and
transmit, when a transaction request is generated through the abnormal node, the transaction request to the normal node, and cooperatively process the transaction request through the abnormal node and the normal node.

19. The non-transitory computer-readable storage medium according to claim 18, wherein the plurality of instructions, in order to cause the processor to perform availability detection on each of the blockchain nodes, is configured to cause the processor to:
store the transaction data generated through the blockchain network into a transaction cache pool;
package, when a preset block upload condition is met, the transaction data stored in the transaction cache pool, to generate a to-be-uploaded current block; and
perform availability detection on each of the blockchain nodes according to transaction data recorded in the current block.

20. The non-transitory computer-readable medium according to claim 19, wherein the plurality of instructions, in order to further cause the processor to perform availability detection on each of the blockchain nodes, is configured to cause the processor to:
count a quantity of transaction failures and a transaction failure rate of each of the blockchain nodes according to the transaction data recorded in the current block;
determine, when the quantity of transaction failures and the transaction failure rate of the blockchain node each reach a corresponding parameter threshold, that the blockchain node is an abnormal node with availability failure; and
determine, when at least one of the quantity of transaction failures or the transaction failure rate of the blockchain node does not reach the corresponding parameter threshold, that the blockchain node is an available normal node.
